(19) United States
(12) Patent Application Publication
(10) Pub. No.: US 2024/0098284 A1
(43) Pub. Date: Mar. 21, 2024

(54) SYSTEMS AND METHODS FOR DIGITAL IMAGE COMPRESSION

(71) Applicant: Illinois Tool Works Inc., Glenview, IL (US)

(72) Inventors: Joseph Schlecht, Edina, MN (US); Eric Ferley, Minneapolis, MN (US)

(21) Appl. No.: 18/453,362

(22) Filed: Aug. 22, 2023

Related U.S. Application Data
(60) Provisional application No. 63/406,827, filed on Sep. 15, 2022.

(51) Int. Cl. H04N 19/29; H04N 19/136; H04N 19/17; H04N 19/182; H04N 19/184; H04N 19/423

(52) U.S. Cl. CPC H04N 19/29; H04N 19/136; H04N 19/17; H04N 19/182; H04N 19/184; H04N 19/423

(57) ABSTRACT

Described herein are examples of imaging systems for digital image processing. For example, techniques are disclosed for dynamic compression of individual regions representing pixels and/or voxels of high-resolution digital images. During image data compression, first regions may be scaled based on a first scaling value, whereas second region may be scaled based on a second scaling value. During image data decompression and image reconstruction, a third scaling value is applied to both first and second regions.

### CROSS REFERENCE TO RELATED APPLICATIONS

This application is a Non-Provisional patent application of U.S. Provisional Patent Application No. 63/406,827 entitled “Systems And Methods For Digital Image Compression” filed Sep. 15, 2022, which is herein incorporated by reference in its entirety.

### TECHNICAL FIELD

The present disclosure generally relates to digital image processing and, more particularly, to systems and methods for digital image compression and/or decompression processes.

### BACKGROUND

Industrial radiography imaging systems are used to acquire two-dimensional (2D) and/or three-dimensional (3D) radiographic images of parts used in industrial applications. Such industrial applications might include, for example, aerospace, automotive, electronic, medical, pharmaceutical, military, and/or defense applications. The radiographic images may be stored for later access and/or manipulation. However, the images may have a large file size and may not be easily reconstructed.

Accordingly, systems and methods to improve image storage and reconstruction are desirable.

Limitations and disadvantages of conventional and traditional approaches will become apparent to one of skill in the art, through comparison of such systems and methods with the present disclosure as set forth in the remainder of the present application with reference to the drawings.

### BRIEF SUMMARY

The present disclosure is directed to high resolution imaging processes, including compression, storage and/or reconstruction of digital images, substantially as illustrated by and/or described in connection with at least one of the figures, and as set forth more completely in the claims.

These and other advantages, aspects and novel features of the present disclosure, as well as details of an illustrated example thereof, will be more fully understood from the following description and drawings.

### BRIEF DESCRIPTION OF THE DRAWINGS

FIG. 1 shows an example of an imaging machine, in accordance with aspects of this disclosure.

FIG. 2 is a block diagram showing an example system employing the imaging machine of FIG. 1, in accordance with aspects of this disclosure.

FIGS. 3A and 3B illustrate an example image represented by image data subject to processing from the imaging machine of FIGS. 1 and 2, in accordance with aspects of this disclosure.

FIGS. 4A and 4B illustrate another example image represented by image data subject to processing from the imaging machine of FIGS. 1 and 2, in accordance with aspects of this disclosure.

FIGS. 5A and 5B are flowcharts illustrating example operations of an imaging process of the imaging system of FIGS. 1 and 2, in accordance with aspects of this disclosure.

The figures are not necessarily to scale. Where appropriate, the same or similar reference numerals are used in the figures to refer to similar or identical elements.

### DETAILED DESCRIPTION

The present disclosure is directed to systems and methods for digital image processing. For example, techniques are disclosed for compression of individual regions representing pixels and/or voxels of high-resolution digital images. In some examples, the images are obtained through an industrial radiography imaging process.

Image compression techniques are designed to compress and reconstruct digital images to facilitate storage and/or transmission of large digital files. This can include a variety of digital image types and formats, including 2D and 3D images, constructed of pixels and voxels, respectively. In conventional compression systems, raw volumetric data corresponding to the image is scaled to a smaller unit for storage or transmission, such as scaling each voxel of the image as 32-bit floating point voxels (e.g., single-precision floating-point format) to 8-bit or 16-bit volumes, thereby reducing the file size.

In conventional systems, the above scaling and exporting approach (e.g., from a 32-bit to 8-bit or 32 to 16-bit) results in undesirable quantization effects. For instance, if the image volume has a wide range of density (e.g., voxel gray values), the scaling can result in loss of data/image quality, as well as slow reconstruction of the image.

The disclosed systems and methods result in an advanced technique, by scaling image data from an initial value, depth, volume, or size (e.g., 32-bit) to one or more secondary values, depths, volumes, or sizes (e.g., 8 or 16-bit) based on one or more characteristics (i.e. minimum and/or maximum volume values). In particular, for three-dimensional images, a total volume of the image can be defined as containing a plurality of individual regions with the total volume. In some examples, one or more of the regions correspond to a voxel with a defined value, depth, size, or volume (e.g. a 32×32×32, 32-bit voxel “bricks”). In some examples, each region or brick has a common value, whereas in other examples two regions or bricks may be defined by different values.

During compression of the image data (e.g., to store and/or transmit the image data), the initial value (e.g., a range of values, which may include 32-bit minimum/maximum volume values) for each region is scaled to one or more secondary values (e.g., a range of values, such as 8 or 16-bit minimum/maximum volume values). In particular, a first region of the plurality of regions can be scaled from a 32-bit volume to an 8-bit volume, as a second region of the plurality of regions can be scaled from a 32-bit volume to a 16-bit volume. Identification of regions and assignment of one of the different compression scales (e.g., over a range of values, such as 8 or 16-bit values) can be implemented based on one or more characteristics of the image, such as a gray value range, a gray value distribution (e.g., quantization), noise in the image, contrast, density, location within the image, or other suitable characteristics. For example, the characteristics may correspond to a value and/or a range of values for a range of shades of gray in a particular pixel or voxel. As such, the compression or scaling value can be any suitable number within a range of, for example, 0-32-bit values.

The compressed and stored image data can be decompressed for reconstruction (e.g., in response to a user command), such that each region (e.g., 8 or 16-bit) is read from storage and rescaled according to one or more values (e.g., 32-bit floating point values). In some examples, each region is rescaled to a single value regardless of compressed value. Thus, regions with both an 8 or 16-bit compression value are rescaled to a 32-bit value for presentation.

Advantageously, images stored in accordance with the disclosed systems and methods show a significant decrease in quantization of the image, offer a reduction in storage requirements (e.g., from a total, initial 32-bit value to scaled 8 or 16-bit value), and an increase in reconstruction speed, as a result of standardized reading/writing, and efficient data management of the scaled image data.

Thus, as disclosed herein, localized scaling/rescaling of the image data (based on dynamic scaling of the initial image data) yields a higher dynamic range than conventional 8 or 16-bit conversion techniques.

In disclosed examples, a method of compressing digital image data of an object includes identifying a plurality of regions in the digital image of the object; assigning a first bit value to a first region of the plurality of regions; compressing digital image data associated with the first region based on the assigned first bit value; assigning a second bit value to a second region of the plurality of regions; compressing digital image data associated with the second region based on the assigned second bit value; and storing the compressed digital image data associated with the first region and the second region on a storage medium.

In some examples, the method further includes accessing the storage medium; assigning a third bit value to the first region and the second region of the plurality of regions; decompressing the compressed digital image data associated with the first region and the second region based on the assigned third bit value; and reconstructing the digital image of the object based on the third bit value.

In some examples, the method further includes presenting the digital images to a user via one or more output devices.

In some examples, the first bit value is 8-bit. In some examples, the second bit value is 16-bit. In some examples, the third bit value is 32-bit. In some examples, the digital image is comprised of a plurality of voxels or pixels. In some examples, each voxel or pixel of the plurality of voxels corresponds to a region of the plurality of regions. In some examples, a size of each voxel or pixel ranges from tens to hundreds of micrometers. In some examples, each region of the plurality of regions corresponds to a voxel or a pixel of the plurality of voxels or pixel.

In some examples, the method further includes scanning the object with a radiation emission source to generate a digital image of the object.

In some examples, the first bit value and the second bit value are a common bit value.

In some examples, the method further includes assigning a fourth bit value to a third region of the plurality of regions; compressing digital image data associated with the third region based on the assigned fourth bit value; and storing the compressed digital image data associated with the third region.

In some disclosed examples, an industrial imaging system includes an adjustable fixture configured to position an object; a detector configured to capture radiation from the object; and an image acquisition system configured to generate an image of the object based on the detected radiation, the image acquisition system comprising: a user interface comprising an input device, processing circuitry, and memory circuitry comprising machine readable instructions which, when executed by the processing circuitry, cause the processing circuitry to: receive, via the detector, digital image data corresponding to the object; identifying a plurality of regions in the digital image; receive, via the input device, a selection of a first bit depth to a first region of the plurality of regions; receive, via the input device, a selection of a second bit depth to a second region of the plurality of regions; compress the digital image data associated with the first region based on the assigned first bit depth; compress the digital image data associated with the second region based on the assigned second bit depth; and storing the compressed data digital image data associated with the first and second regions on the memory circuitry.

In some examples, the processing circuitry is further operable to store the compressed digital image data associated with the second region on the storage medium.

In some examples, a radiation emitter transmits radiation toward the object to be received by the detector.

In some examples, the detector is a sensor panel comprising one or more of a charge coupled device (CCD) panel, or a complementary metal-oxide-semiconductor (CMOS) panel.

In some disclosed examples, a method of compressing digital image data of an object comprising: identifying a plurality of regions in the digital image of the object; determining one or more characteristics of each identified region of the plurality of regions; assigning a bit value to each identified region of the plurality of regions based on the one or more characteristics; compressing digital image data associated with each identified region based on the assigned bit value; and storing the compressed digital image data associated with each identified region on a storage medium.

In some disclosed examples, the method further includes comparing the determined one or more characteristics to a list that associates characteristic data with a desired bit value; and determining the assigned bit value based on the comparison.

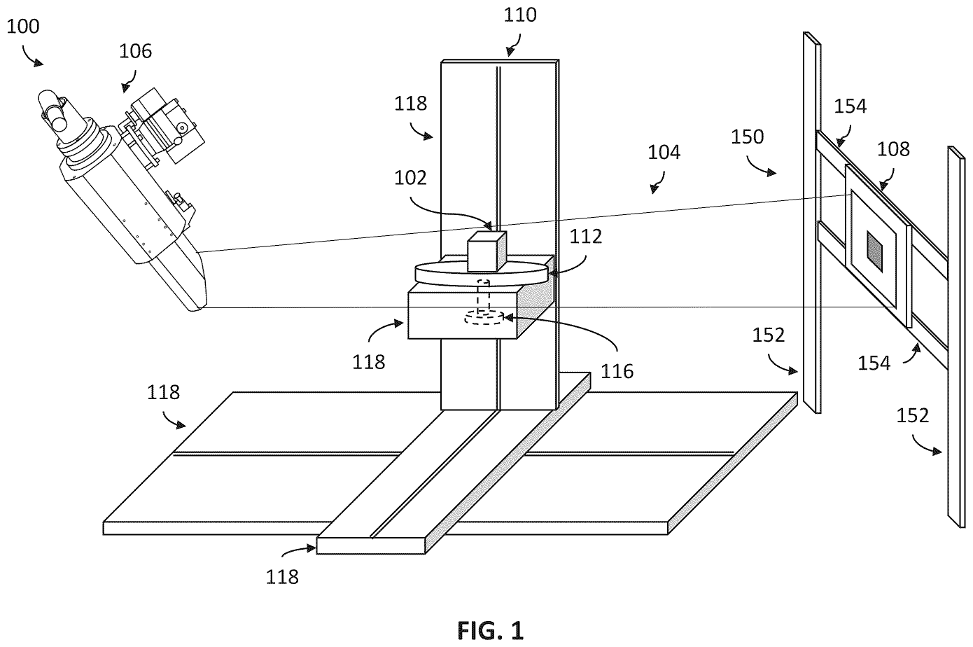

FIG. 1 shows an example imaging machine 100. In some examples, the imaging machine 100 may be an X-ray radiography machine 100 may be used to perform non-destructive testing (NDT), digital radiography (DR) scans, computerized tomography (CT) scans, and/or other applications on an object 102. Although some examples are provided with respect to an imaging system, such as industrial imaging system 100, the compression and/or decompression systems and method disclosed herein are applicable to image data generally, regardless of the source of the image data or the technique used to acquire the image data.

In some examples, the object 102 may be an industrial component and/or an assembly of components (e.g., an engine cast, microchip, bolt, etc.). In some examples, the object 102 may be relatively small, such that a finer, more detailed, higher resolution radiographic imaging process may be useful. While some examples are discussed in terms of X-rays for the sake of simplicity, in some examples, the industrial X-ray radiography machines 100 discussed herein may use radiation in other wavelengths (e.g., Gamma, Neutron, etc.).

In the example of FIG. 1, the imaging machine 100 directs radiation 104 (e.g., X-ray) from an emitter 106, through the object 102, to a detector 108. In some examples, two-dimensional (2D) digital images (e.g., radiographic images, X-ray images, etc.) may be generated based on the radiation 104 incident on the detector 108. In some examples, the 2D images may be generated by the detector 108 itself. In some examples, the 2D images may be generated by the detector 108 in combination with a computing system in communication with the detector 108.

In some examples, the 2D images may be constantly captured/acquired by the detector 108 (e.g., in a free run mode) at a given frame rate, as long as the detector 108 is powered. However, in some examples, the 2D images may only be fully generated by the detector 108 (and/or associated computing system(s)) when a scanning/imaging process has been selected and/or is running. Likewise, in some examples, the 2D images may be saved in permanent (i.e., non-volatile) memory when a scanning/imaging process has been selected and/or is running.

In some examples, the 2D images generated by the detector 108 (and/or associated computing system(s)) may be combined to form three dimensional (3D) volumes and/or images comprising voxels. In some examples, 2D image slices of the 3D volumes/images may also be formed. While the term “image” is used herein as a shorthand, it should be understood that an “image” may comprise representative data 102 until that data is visually rendered by one or more appropriate components (e.g., a display screen, a graphic processing unit, detector 108, etc.).

In some examples, the detector 108 may comprise a flat panel detector (FDA), a linear diode array (LDA), and/or a lens-coupled scintillation detector. In some examples, the detector 108 may comprise a fluoroscopy detection system and/or a digital image sensor configured to receive an image indirectly via scintillation. In some examples, the detector 108 may be implemented using a sensor panel (e.g., a charge coupled device (CCD) panel, a complementary metal-oxide-semiconductor (CMOS) panel, etc.) configured to receive the X-rays directly, and to generate the digital images. In some examples, the detector 108 may include a scintillation layer/screen that absorbs radiation and emits visible light photons that are, in turn, detected by a solid-state detector panel (e.g., a CMOS panel and/or CCD panel) coupled to the scintillation screen.

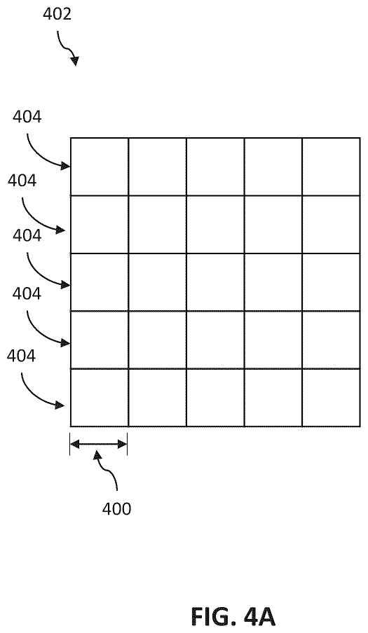

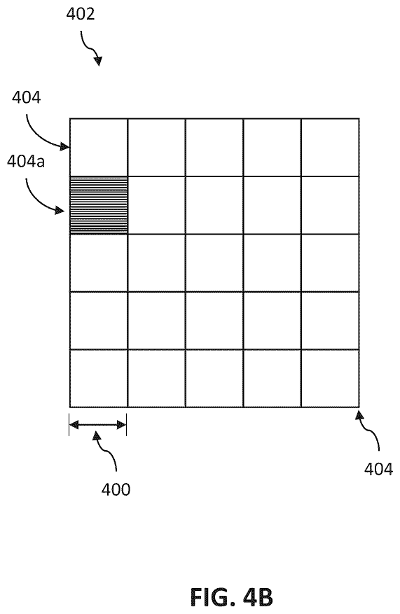

In some examples, the detector 108 (e.g., the solid-state detector panel) may include pixels 404 (see, e.g., FIGS. 4A, 4B). In some examples, the pixels 404 may correspond to portions of a scintillation screen. In some examples, the size of each pixel 404 may range from tens to hundreds of micrometers. In some examples, the pixel size, and therefore the voxel size, of the detector 108 may be in the range of 25 micrometers to 250 micrometers (e.g., 200 micrometers), however pixel and/or voxel sizes in the nanometer scale or larger than 250 micrometers is possible.

In some examples, the 2D image captured by the detector 108 (and/or associated computing system) may contain features finer (e.g., smaller, denser, etc.) than the pixel size of the detector 108. For example, a computer microchip may have very fine features that are smaller than a pixel 404. In such examples, it may be useful to use sub-pixel sampling to achieve a higher, more detailed, resolution than might otherwise be possible.

For example, multiple 2D images of the object 102 may be captured while the object 102 is at the same orientation and the detector 108 is at either of two (or more) different positions. In some examples, the different positions of the detector 108 may be offset from one another by less than the size of a pixel 404 (i.e., a sub-pixel). The multiple sub-pixel shifted 2D images may then be combined (e.g., via an interlacing technique) to form a single higher resolution 2D image of the object 102 at that orientation. Thus, when the term “high resolution imaging process” is used herein, it may refer to an imaging process (e.g., radiography, computed tomography, etc.) in which sub-pixel sampling is used to ensure the resolution (and/or pixel density) of the final image is greater than the resolution (and/or pixel density) of the detector 108 (and/or portion of the detector 108 and/or virtual detector) used to capture the image. While it may be possible to instead translate the object 102, rather than the detector 108, for sub-pixel sampling, moving the object 102 may also alter the imaging geometry, which may negatively impact the resulting combination of images.

In the example of FIG. 1, the imaging machine 100 includes a detector positioner 150 configured to move the detector 108 to different detector positions (e.g., for sub-pixel sampling). As shown, the detector positioner 150 includes two parallel pillars 152 connected by two parallel rails 154. As shown the detector 108 is retained on the rails 154. In some examples, the detector 108 may be retained on (and/or attached to) the rails 154 by one or more intermediary supports.

As the detector 108 may be moved by the detector positioner 150, in some examples, the object 102 may be moved by an object positioner 110. In the example of FIG. 1, the object positioner 110 includes a rotatable fixture 112 upon which the object 102 is positioned. As shown, the rotatable fixture 112 is a circular plate. As shown, the rotatable fixture 112 is attached to a motorized spindle 116, through which the rotatable fixture 112 may be rotated about an axis defined by the spindle 116. In the example of FIG. 1, the rotatable fixture 112 is supported by a support structure 118. In some examples, the support structure 118 may be configured to translate the rotatable fixture 112 (and/or the object 102) toward and/or away from the emitter 106 and/or the detector 108. In some examples, the support structure 118 may include one or more actuators configured to impart the translation(s).

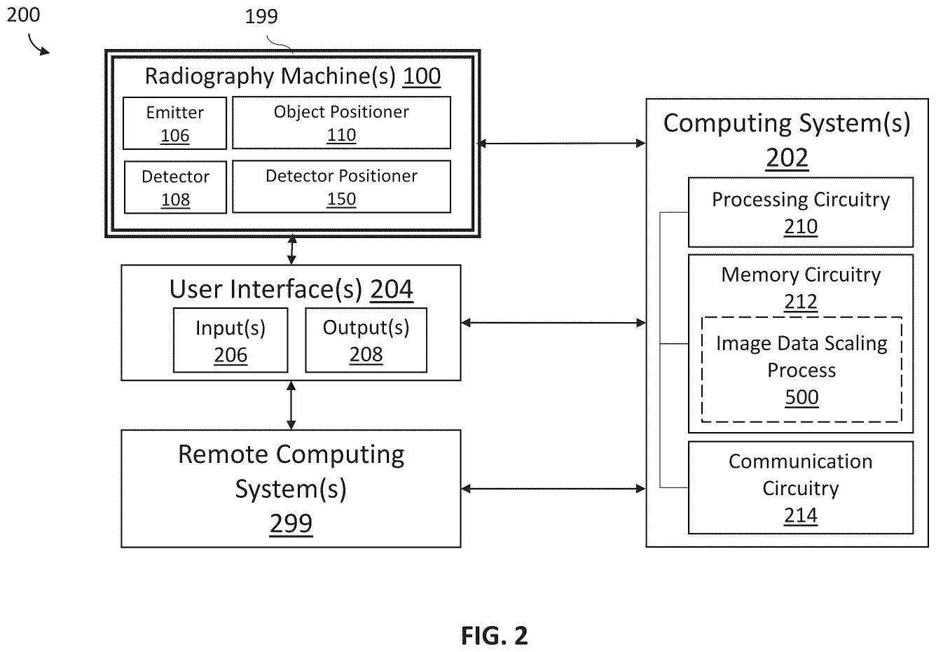

FIG. 2 shows an example of imaging system 200 that includes an imaging machine, such as example imaging machine 100 shown in FIG. 1. As shown, the imaging system 200 also includes a computing system 202, a user interface (UI) 204, and a remote computing system 299. While only one imaging machine 100, computing system 202, UI 204, and remote computing system 299 are shown in the example of FIG. 2, in some examples the system 200 may include several imaging machines 100, computing systems 202, UIs 204, and/or remote computing systems 299.

In the example of FIG. 2, the imaging machine 100 has an emitter 106, detector 108, detector positioner 150, and object positioner 110 enclosed within a housing 199. As shown, the imaging machine 100 is connected to and/or in communication with the computing system(s) 202 and UI(s) 204. In some examples, the imaging system 100 may also be in electrical communication with the remote computing system(s) 299. In some examples, the communications and/or connections may be electrical, electromagnetic, wired, and/or wireless.

In the example of FIG. 2, the UI 204 includes one or more input devices 206 and/or output devices 208. In some examples, the one or more input devices 206 may comprise one or more touch screens, mice, keyboards, buttons, switches, slides, knobs, microphones, dials, and/or other electromechanical input devices. In some examples, the one or more output devices 208 may comprise one or more display screens, speakers, lights, haptic devices, and/or other devices. In some examples, a user may provide input to, and/or receive output from, the imaging machine(s) 100, computing system(s) 202, and/or remote computing system(s) 299 via the UI(s) 204.

In some examples, the UI(s) 204 may be part of the computing system 202. In some examples, the computing system 202 may implement one or more controllers of the imaging machine(s) 100. In some examples, the computing system 202 together with the UI(s) 204 may comprise an image acquisition system of the imaging system 200. In some examples, the remote computing system(s) 299 may be similar or identical to the computing system 202.

In the example of FIG. 2, the computing system 202 is in (e.g., electrical) communication with the imaging machine(s) 100, UI(s) 204, and remote computing system(s) 299. In some examples, the communication may be direct communication (e.g., through a wired and/or wireless medium) or indirect communication, such as, for example, through one or more wired and/or wireless networks (e.g., local and/or wide area networks). As shown, the computing system 202 includes processing circuitry 210 (which may include a graphic processing unit (GPU), memory circuitry 212, and communication circuitry 214 interconnected with one another via a common electrical bus.

In some examples, the processing circuitry 210 may comprise one or more processors. In some examples, the communication circuitry 214 may include one or more wireless adapters, wireless cards, cable adapters, wire adapters, radio frequency (RF) devices, wireless communication devices, Bluetooth devices, IEEE 802.11-compliant devices, WiFi devices, cellular devices, GPS devices, Ethernet ports, network ports, lightning cable ports, cable ports, etc. In some examples, the communication circuitry 214 may be configured to facilitate communication via one or more wired media and/or protocols (e.g., Ethernet cable(s), universal serial bus cable(s), etc.) and/or wireless mediums and/or protocols (e.g., near field communication (NFC), ultra high frequency radio waves (commonly known as Bluetooth), IEEE 802.11x, Zigbee, HART, LTE, Z-Wave, WirelessHD, WiGig, etc.).

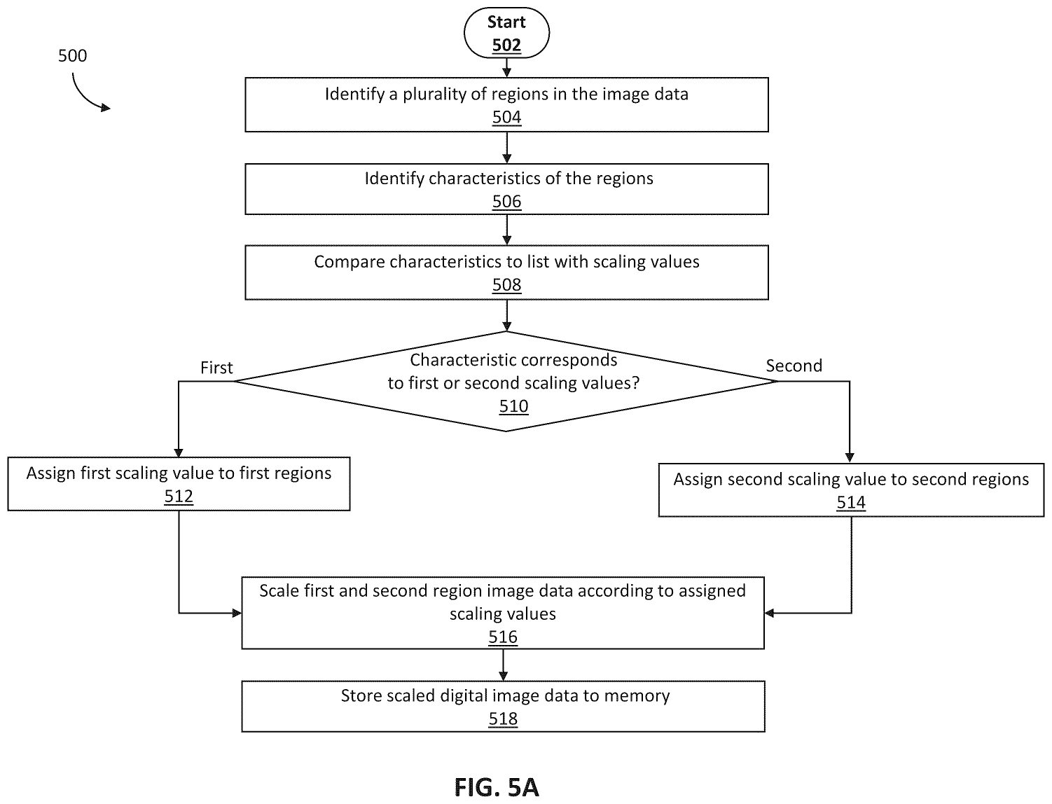

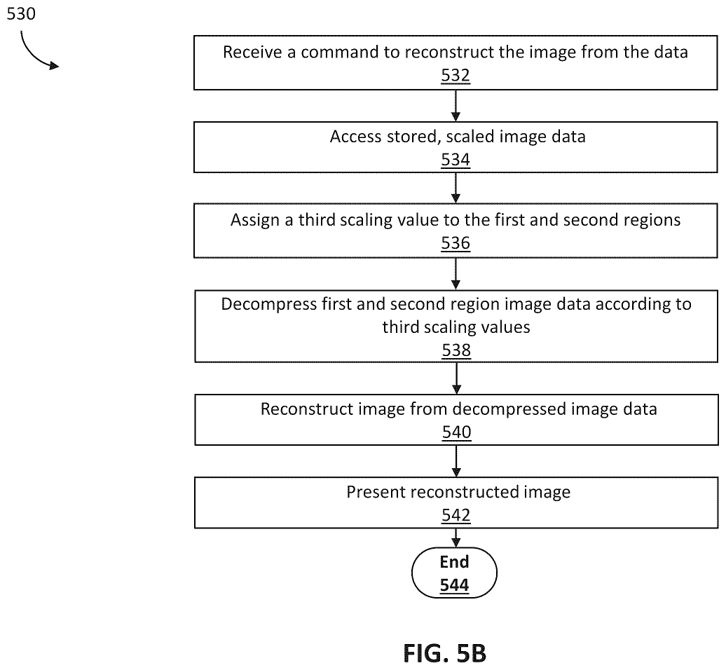

In the example of FIG. 2, the memory circuitry 212 comprises and/or stores an image data scaling process 500/530 (e.g., as shown in FIGS. 5A and 5B). In some examples, the image data scaling process 500/530 may be implemented via machine readable (and/or processor executable) instructions stored in memory circuitry 212 and/or executed by the processing circuitry 210. In some examples, the image data scaling process 500/530 may execute as part of a larger scanning and/or imaging process of the imaging system 200.

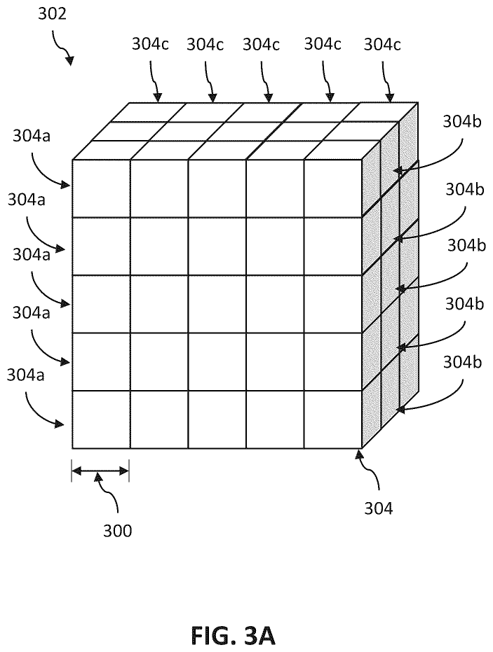

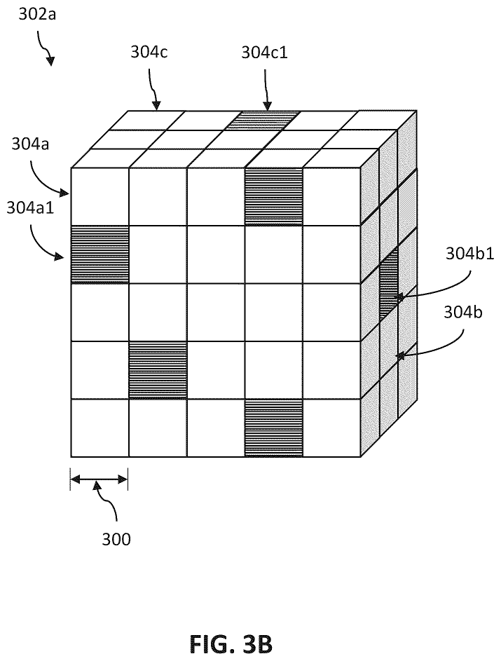

FIGS. 3A and 3B illustrate the concept of identifying a plurality of regions 304 (or voxels) within an image 302 (e.g., a three dimensional image), and assigning a dynamic scaling value to different regions. In particular, the plurality of regions 304 can correspond to a voxel, which represents a value on a grid of cubes arranged in three-dimensional space, as shown in the image data 302 of FIGS. 3A and 3B.

As shown, the figure depicts image data as a cuboid with a first grid of regions 304a, a second grid of regions 304b, and a third grid of regions 304c. In the example of FIGS. 3A and 3B, each region corresponds to a voxel, with a defined size value 300. Although image data is depicted as a cuboid, image data from any geometric shape of varying complexity could be subjected to the compression/reconstruction techniques disclosed herein.

As illustrated in FIG. 3B, one or more regions or voxels 304 can be identified as presenting one or more characteristics corresponding to a scaling value. As shown, first regions 304a, 304b, and 304c have been identified as presenting a first characteristic (e.g., a first density value, a first contrast value, etc.), whereas second regions 304a1, 304b1, and 304c1 (shown with shading for clarity) have been identified as presenting a second characteristic (e.g., a second density value, a second contrast value, etc.). A first scaling value (e.g., an 8-bit depth or value) can then be assigned to the first regions (e.g., via processing circuitry 210), whereas a second scaling value (e.g., a 16-bit depth or value) can be assigned to the second regions.

Although several examples are provided with respect to a three dimensional image (corresponding to a model of a three dimensional object), the principles and techniques disclosed herein are applicable to two-dimensional images as well. As shown in FIGS. 4A and 4B, the disclosed compression/restructuring techniques described herein are applied to pixels within image data.

In the example of FIG. 4A, a plurality of regions 404 (or pixels) within an image 402 (e.g., a two dimensional image), and assigning a dynamic scaling value to different regions. In particular, the plurality of regions 304 can correspond to a pixel, which represents a value on a grid of square arranged in two-dimensional space, as shown in the image data 302 of FIGS. 4A and 4B.

As shown, the figure depicts image data as squares within a grid of regions 404, each with a defined size value 400. As illustrated in FIG. 4B, one or more regions or pixel 404 can be identified as presenting one or more characteristics corresponding to a scaling value. As shown, first regions 404 have been identified as presenting a first characteristic (e.g., a first density value, a first contrast value, etc.), whereas a second region 404a (shown with shading for clarity) has been identified as presenting a second characteristic (e.g., a second density value, a second contrast value, etc.). A first scaling value (e.g., an 8-bit depth or value) can then be assigned to the first regions (e.g., via processing circuitry 210), whereas a second scaling value (e.g., a 16-bit depth or value) can be assigned to the second region(s).

FIG. 5A is a flowchart illustrating example operation of a digital image data scaling process 500. In the example of FIG. 5A, the digital image data scaling process 500 (e.g., compression, decompression, and/or reconstruction) begins at block 502. At block 504, the process 500 identifies a plurality of regions in the digital image of the object. For example, each region may correspond to a voxel or a pixel, and each region may be of equal size.

In block 506, one or more characteristics of each identified region is determined. For example, data corresponding to a given region may be compared to a list of characteristics that associates characteristic data with a desired scaling value, depth, volume, or size (e.g., desired compression values) in block 508. In some examples, the list is stored on the memory circuit 212, but can be additionally or alternatively stored on remote computing systems 299.

Based on the comparison, a scaling value, depth, volume, or size corresponding to each region is identified in block 510. For example, a first scaling value, depth, volume, or size may be identified for regions with a first characteristic, and a second value, depth, volume, or size may be identified for regions with a second characteristic. In some examples, the scaling value is a bit value or bit depth of the voxel and/or pixel in the image data.

In block 512, a first scaling value, depth, volume, or size (e.g., bit value) is assigned to a first region of the plurality of regions, and a second scaling value, depth, volume, or size (e.g., bit value) is assigned to a second region of the plurality of regions in block 514. Although certain examples are provided describing the plurality of regions within the image data as being divisible as first and second regions, the image data is not limited to two regions or types of regions. For example, three, four, or more regions (e.g., an unlimited number of regions) are possible, each of which may be assigned a common scaling value or any of a variety of scaling values (e.g., based on one or more characteristics of each region).

In block 516, the digital image data associated with the first and second regions are scaled/compressed based on the corresponding scaling value. In block 518, the scaled/compressed digital image data associated with the first and second regions are written to a storage medium (e.g., memory circuit 212, remote computing system 299).

The scaled and stored image data in FIG. 5A can be decompressed and reconstructed in the flowchart of FIG. 5B, illustrating example digital image data scaling process 530. In the example of FIG. 5B, the digital image data scaling process 530 (e.g., decompression and/or reconstruction) begins at block 532, where the system receives a command to reconstruct the compressed and stored image data, such as via UI 204 or remote computing system 299. In block 534, the storage medium is accessed to scale the image data. In block 536, a third scaling value is assigned to both the first and the second regions, such that image data associated with both regions is decompressed in block 538. Having scaled the image data to the third scaling value (e.g., from 8 or 16-bit values to 32-bit values), the digital image of the object is reconstructed in block 540. In some examples, the reconstructed digital image is presented in block 542, such as to a display. The process ends at block 544.

The present methods and/or systems may be realized in hardware, software, or a combination of hardware and software. The present methods and/or systems may be realized in a centralized fashion in at least one computing system, or in a distributed fashion where different elements are spread across several interconnected computing and/or remote computing systems. Any kind of computing system or other apparatus adapted for carrying out the methods described herein is suited. A typical combination of hardware and software may be a general-purpose computing system with a program or other code that, when being loaded and executed, controls the computing system such that it carries out the methods described herein. Another typical implementation may comprise an application specific integrated circuit or chip. Some implementations may comprise a non-transitory machine-readable (e.g., computer readable) medium (e.g., FLASH drive, optical disk, magnetic storage disk, or the like) having stored thereon one or more instructions (e.g., lines of code) executable by a machine, thereby causing the machine to perform processes as described herein.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. Therefore, it is intended that the present method and/or system not be limited to the particular implementations disclosed, but that the present method and/or system will include all implementations falling within the scope of the appended claims.

As used herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”.

As utilized herein, the terms “e.g.,” and “for example” set off lists of one or more non-limiting examples, instances, or illustrations.

As used herein, the terms “coupled,” “coupled to,” and “coupled with,” each mean a structural and/or electrical connection, whether attached, affixed, connected, joined, fastened, linked, and/or otherwise secured. As used herein, the term “attach” means to affix, couple, connect, join, fasten, link, and/or otherwise secure. As used herein, the term “connect” means to attach, affix, couple, join, fasten, link, and/or otherwise secure.

As used herein the terms “circuits” and “circuitry” refer to physical electronic components (i.e., hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code. As utilized herein, circuitry is “operable” and/or “configured” to perform a function whenever the circuitry comprises the necessary hardware and/or code (if any is necessary) to perform the function, regardless of whether performance of the function is disabled or enabled (e.g., by a user-configurable setting, factory trim, etc.).

As used herein, a control circuit may include digital and/or analog circuitry, discrete and/or integrated circuitry, microprocessors, DSPs, etc., software, hardware and/or firmware, located on one or more boards, that form part or all of a controller, and/or are used to control a welding process, and/or a device such as a power source or wire feeder.

As used herein, the term “processor” means processing devices, apparatus, programs, circuits, components, systems, and subsystems, whether implemented in hardware, tangibly embodied software, or both, and whether or not it is programmable. The term “processor” as used herein includes, but is not limited to, one or more computing devices, hardwired circuits, signal-modifying devices and systems, devices and machines for controlling systems, central processing units, programmable devices and systems, field-programmable gate arrays, application-specific integrated circuits, systems on a chip, systems comprising discrete elements and/or circuits, state machines, virtual machines, data processors, processing facilities, and combinations of any of the foregoing. The processor may be, for example, any type of general purpose microprocessor or microcontroller, a digital signal processing (DSP) processor, an application-specific integrated circuit (ASIC), a graphic processing unit (GPU), a reduced instruction set computer (RISC) processor with an advanced RISC machine (ARM) core, etc. The processor may be coupled to, and/or integrated with a memory device.

As used, herein, the term “memory” and/or “memory device” means computer hardware or circuitry to store information for use by a processor and/or other digital device. The memory and/or memory device can be any suitable type of computer memory or any other type of electronic storage medium, such as, for example, read-only memory (ROM), random access memory (RAM), cache memory, compact disc read-only memory (CDROM), electro-optical memory, magneto-optical memory, programmable read-only memory (PROM), erasable programmable read-only memory (EPROM), electrically-erasable programmable read-only memory (EEPROM), a computer-readable medium, or the like. Memory can include, for example, a non-transitory memory, a non-transitory processor readable medium, a non-transitory computer readable medium, non-volatile memory, dynamic RAM (DRAM), volatile memory, ferroelectric RAM (FRAM), first-in-first-out (FIFO) memory, last-in-first-out (LIFO) memory, stack memory, non-volatile RAM (NVRAM), static RAM (SRAM), a cache, a buffer, a semiconductor memory, a magnetic memory, an optical memory, a flash memory, a flash card, a compact flash card, memory cards, secure digital memory cards, a microcard, a minicard, an expansion card, a smart card, a memory stick, a multimedia card, a picture card, flash storage, a subscriber identity module (SIM) card, a hard drive (HDD), a solid state drive (SSD), etc. The memory can be configured to store code, instructions, applications, software, firmware and/or data, and may be external, internal, or both with respect to the processor.

What is claimed is:

1. A method of compressing digital image data of an object comprising:
identifying a plurality of regions in the digital image of the object;
assigning a first bit value to a first region of the plurality of regions;
compressing digital image data associated with the first region based on the assigned first bit value;
assigning a second bit value to a second region of the plurality of regions;
compressing digital image data associated with the second region based on the assigned second bit value; and
storing the compressed digital image data associated with the first region and the second region on a storage medium.

2. The method of claim 1, further comprising:
accessing the storage medium;
assigning a third bit value to the first region and the second region of the plurality of regions;
decompressing the compressed digital image data associated with the first region and the second region based on the assigned third bit value; and
reconstructing the digital image of the object based on the third bit value.

3. The method of claim 1, further comprising presenting the digital images to a user via one or more output devices.

4. The method of claim 1, wherein the first bit value is 8-bit.

5. The method of claim 1, wherein the second bit value is 16-bit.

6. The method of claim 1, wherein the third bit value is 32-bit.

7. The method of claim 1, wherein the digital image is comprised of a plurality of voxels or pixels.

8. The method of claim 7, wherein each voxel or pixel of the plurality of voxels corresponds to a region of the plurality of regions.

9. The method of claim 7, wherein a size of each voxel or pixel ranges from tens to hundreds of micrometers.

10. The method of claim 7, wherein each region of the plurality of regions corresponds to a voxel or a pixel of the plurality of voxels or pixel.

11. The method of claim 1, further comprising scanning the object with a radiation emission source to generate a digital image of the object.

12. The method of claim 1, wherein the first bit value and the second bit value are a common bit value.

13. The method of claim 1, further comprising:
assigning a fourth bit value to a third region of the plurality of regions;
compressing digital image data associated with the third region based on the assigned fourth bit value; and
storing the compressed digital image data associated with the third region.

14. An industrial imaging system, comprising:
an adjustable fixture configured to position an object;
a detector configured to capture radiation from the object; and
an image acquisition system configured to generate an image of the object based on the detected radiation, the image acquisition system comprising:
a user interface comprising an input device,
processing circuitry, and
memory circuitry comprising machine readable instructions which, when executed by the processing circuitry, cause the processing circuitry to:
receive, via the detector, digital image data corresponding to the object;
identifying a plurality of regions in the digital image;
receive, via the input device, a selection of a first bit depth to a first region of the plurality of regions;
receive, via the input device, a selection of a second bit depth to a second region of the plurality of regions;
compress the digital image data associated with the first region based on the assigned first bit depth;
compress the digital image data associated with the second region based on the assigned second bit depth; and
storing the compressed data digital image data associated with the first and second regions on the memory circuitry.

15. The system of claim 14, wherein the processing circuitry is further operable to store the compressed digital image data associated with the second region on the storage medium.

16. The system of claim 14, further comprising a radiation emitter to transmit radiation toward the object to be received by the detector.

17. The system of claim 14, wherein the detector is a sensor panel comprising one or more of a charge coupled device (CCD) panel, or a complementary metal-oxide-semiconductor (CMOS) panel.

18. A method of compressing digital image data of an object comprising:
identifying a plurality of regions in the digital image of the object;
determining one or more characteristics of each identified region of the plurality of regions;
assigning a bit value to each identified region of the plurality of regions based on the one or more characteristics;
compressing digital image data associated with each identified region based on the assigned bit value; and
storing the compressed digital image data associated with each identified region on a storage medium.

19. The method of claim 18, further comprising:
comparing the determined one or more characteristics to a list that associates characteristic data with a desired bit value; and
determining the assigned bit value based on the comparison.

20. The method of claim 19, wherein one of the assigned bit value or the desired bit value is 8-bit, 16-bit, or 32-bit.
